(19) United States
(12) Patent Application Publication
(10) Pub. No.: US 2025/0061327 A1
(43) Pub. Date: Feb. 20, 2025

(54) SUPER-RESOLUTION OF RADAR POINT CLOUDS USING DIFFUSION-BASED GENERATIVE MODELING

(71) Applicant: Robert Bosch GmbH, Stuttgart (DE)

(72) Inventors: Marcus A. Pereira, Pittsburgh, PA (US); Filipe Condessa, Pittsburgh, PA (US); Wan-Yi Lin, Wexford, PA (US); Ravi Ganesh Madan, Ann Arbor, MI (US); Matthias Hagedorn, Sunnyvale, CA (US)

(21) Appl. No.: 18/452,230

(22) Filed: Aug. 18, 2023

(51) Int. Cl. G06N 3/08; G06T 3/4046; G06T 3/4053

(52) U.S. Cl. CPC G06N 3/08; G06T 3/4046; G06T 3/4053

(57) ABSTRACT

Disclosed embodiments use diffusion-based generative models for radar point cloud super-resolution. Disclosed embodiments use the mathematics of diffusion modeling to generate higher-resolution radar point cloud data from lower-resolution radar point cloud data.

### TECHNICAL FIELD

The present disclosure relates generally to the field of artificial intelligence. More specifically, disclosed embodiments relate to employing diffusion models to generate high-resolution radar data from data received by low-resolution radar.

### BACKGROUND

Radar has been used in vehicles and is beginning to gain research interest and attention as a sensor useful for autonomous vehicles. The continuous push for higher levels of autonomy and higher levels of safety guarantees requires improved perception. Unlike cameras which are sensitive to changes in illumination and LiDAR sensors which are sensitive to adverse weather conditions like fog, rain and snow, radar sensors are known to be robust against these environmental changes and are also known to have much higher ranges (i.e., ˜200 meters). However, radar systems currently are not as popular as sensors used for autonomous vehicles, such as RGB cameras and LiDAR sensors. One reason for this lack of popularity is the noisy data output and sparse data output (i.e., low-resolution) when converted into point clouds. Another reason for radar system lack of popularity is the computational and algorithmic cost involved in the signal processing algorithms for extracting point clouds from the noisy raw radar measurements.

Super-resolution techniques aim to increase the resolution of a given input that has a coarse resolution for assorted reasons, some of which include being compressed for the purposes of low-bandwidth transmission or obtained from a low-cost sensor that will sense at a lower resolution than the desired due to sensor design trade-offs (e.g., temporal resolution vs. spatial resolution) or other system design, cost, or efficiency considerations. Super-resolution has been explored for RGB images and some deep-learning-based algorithms have been proposed for this task.

### SUMMARY

Recently, diffusion-based generative models were introduced as a potential solution for RGB image super-resolution that can generate high-resolution and photorealistic images from low-resolution images. These models represent improvement over prior works on generative modeling and on more traditional super-resolution approaches (e.g., optimization, compressive sensing, signal processing, etc.), in that, their training is stable, they do not suffer from mode collapse, and they can generate high-resolution and high-quality synthetic data. The prior art has only been developed and tested on synthetic shape point clouds (such as from the ShapeNet dataset), RGB images obtained from cameras, and LiDAR point clouds.

The combination of diffusion-based generative modeling and super-resolution is an attractive approach to help address the problem of sparsity in radar point cloud data with the goal of increasing the resolution of the point cloud obtained from low-cost radar sensors. A high-resolution radar point cloud could serve as a source of information that is at least on-par with camera and LiDAR sensors for downstream detection and path-planning algorithms.

To date, there has been some work done on inpainting, generating LiDAR point clouds, and super-resolution for images. However, there has been little or no work on applying diffusion-based generative models to radar point clouds for generative modeling applications.

Disclosed embodiments use diffusion-based generative models for radar point cloud super-resolution. Known diffusion modeling algorithms may be slow due to an iterative generation process and, therefore, may not be suitable for real-time applications. Disclosed embodiments may speed up the generation process by distillation of diffusion models allowing as little as a single step for generation. Disclosed embodiments may provide an option to trade-off data quality for more computational cost by using more than one step for generation.

Some disclosed embodiments include methods comprising: sampling a radar point cloud dataset to generate a mini-batch of samples from the dataset, wherein the radar point cloud dataset corresponds to a first resolution; computing noisy data samples for each sample in the mini-batch of samples; computing a conditioning input for each of the samples in the mini-batch, wherein the conditioning input is derived from low-resolution radar point cloud samples corresponding to each sample in the mini-batch with the low-resolution samples corresponding to a second resolution which is lower than the first resolution; and training the diffusion model on the mini-batch of samples and the conditioning input.

Some disclosed embodiments include methods comprising: receiving a first sample of a radar point cloud, the first sample corresponding to a first resolution, the first sample including a first level of noise; computing conditioning input from a radar point cloud corresponding to a second resolution, wherein the second resolution is lower than the first resolution; and applying a trained diffusion model to the first sample and conditioning input to produce a second sample corresponding to the first resolution and including a level of noise lower than the first level of noise.

Some disclosed embodiments include systems comprising: one or more processors; and memory including processor-executable instructions that when executed by the one or more processors causes the system to perform operations including: sampling a radar point cloud dataset to generate a mini-batch of samples from the dataset, wherein the radar point cloud dataset corresponds to a first resolution; computing noisy data samples for each sample in the mini-batch of samples; computing a conditioning input for each of the samples in the mini-batch, wherein the conditioning input is derived from low-resolution radar point cloud samples corresponding to each sample in the mini-batch with the low-resolution samples corresponding to a second resolution which is lower than the first resolution; and training the diffusion model on the mini-batch of samples and the conditioning input.

### BRIEF DESCRIPTION OF THE DRAWINGS

FIG. 1 illustrates a flowchart of an example method in accordance with disclosed embodiments.

FIG. 2 illustrates a flowchart of an example method in accordance with disclosed embodiments.

FIG. 3 illustrates an example embodiment of a general computer system in accordance with the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Disclosed embodiments advantageously leverage mathematical principles of diffusion-based generative modeling. In deep generative modeling, a deep neural network is trained to approximate the data distribution of a given dataset and can be used to generate new data samples that share similar characteristics to those from the original dataset. Diffusion-based models generally have a stable training procedure, do not suffer from mode collapse, and have good mode coverage. As such, diffusion-based modeling may overcome problems that have plagued prior-art deep generative modeling techniques. Additionally, some diffusion-based models can be used to generate very high-quality data samples. The research of diffusion-based models has been focused on RGB image data. Some research has attempted to extend diffusion-based models to other data types, such as audio and point clouds.

A commonly used variant of diffusion models in literature is called Denoising Diffusion Probabilistic Models (DDPMs). In the DDPM framework, a sample from a given dataset is corrupted by gradually adding Gaussian noise over a large number of steps such that the sample at the end can be assumed to be drawn from a Gaussian distribution. Then, a neural network is trained to reverse this noising process and gradually denoise the data sample over a large number of steps to approximate the original sample from the given dataset. Consider a data sample z₀, where the subscript 0 indicates the original clean data sample, to which we gradually add Gaussian noise over multiple steps {1, 2, 3, . . . , N} to obtain z_{N}. When Nis sufficiently large, we can assume that the final noisy sample z_{N} has a standard normal distribution p(z_{N})˜ [symbol] (0, I). The joint distribution of the noisy samples is given by

$$p ( {z}_{1 : N} \vert {z}_{0} ) = {\prod }_{i = 0}^{N - 1} p ( {z}_{i + 1} \vert {z}_{i} ) \qquad ( 1 )$$

where, p(zᵢ₊₁|zᵢ)˜ [symbol] (\sqrt{1−αᵢ}zᵢ, αᵢI) is known as the transition-probability and αᵢ<1 is a fixed sequence of scalars that determines the amount of noise that is gradually added and the amount of signal that is gradually removed at each step. Because of the mathematical simplicity of the corruption process (i.e., it is linear because at each step we simply add noise to the sample from the previous step), one can sample a partially corrupted data sample at any arbitrary step i using

$$p ( {z}_{i} \vert {z}_{0} ) = ( {\prod }_{k = 0}^{i} \sqrt{1 - {α}_{i}} {z}_{0} , ( 1 - {\prod }_{k = 0}^{i} ( 1 - {α}_{i} ) ) I ) . \qquad ( 2 )$$

To generate data samples, we need to learn to reverse the above corruption process starting from a noisy sample drawn from p(z_{N})˜N(0, I). This is also an iterative process wherein noise is gradually removed starting from z_{N} and the joint distribution of the reverse process trajectory is given by

$${p}_{θ} ( {z}_{0 : N - 1} \vert {z}_{N} ) = p ( {z}_{N} ) {\prod }_{i = N - 1}^{0} {p}_{θ} ( {z}_{i} \vert {z}_{i + 1} ) \qquad ( 3 )$$

where, p_{θ}(zᵢ|zᵢ₊₁)= [symbol] (μ_{θ}(zᵢ₊₁, i+1), Σᵢ₊₁) and μ_{θ}(zᵢ₊₁, i+1) is a learned function approximated by a deep neural network parameterized by weights θ. To train the network and learn μ_{θ}(zᵢ₊₁, i+1), the DDPM framework optimizes the lower-bound on the log-likelihood of the data sample. The following two kinds of loss functions can be derived from the log-likelihood bound,
(i.) Mean-squared error between μ_{θ}(zᵢ₊₁, i+1) and a target \tilde{μ}(zᵢ₊₁, i+1)
(ii.) Mean-squared error between ϵ_{θ}(zᵢ₊₁, i+1) and the noise e that is required to obtain zᵢ from z₀ using equation (2)
   It can be shown empirically that the best performance is achieved when using the loss function (ii) above between the predicted noise Ce and the actual noise E.

The procedure for training diffusion models as described above leads to so called unconditional diffusion models. These models can learn the data distribution and once trained, using equation (3) above, one can use the reverse diffusion process to diffuse to an approximate data sample from the original dataset. However, there is no mechanism by which one can control or guide this reverse diffusion process in unconditional diffusion models. This would be needed, for instance, to obtain samples from a specific class or that correspond to some user-provided input. One way to guide diffusion models is to condition the reverse diffusion process using some input that the user can provide which is first processed by another neural network and then fed into the model ϵ_{θ}(zᵢ₊₁, i+1, c) at every step. Here c=f_{ϕ}(user input) is the conditioning input fed to the model ϵ_{θ}, ϕ are the weights of the network that computes the conditioning input for ϵ_{θ} and user input can be anything the user chooses to provide to the diffusion process such as a text-prompt, an image, or data from another sensor.

Disclosed embodiments use the mathematics of diffusion modeling as described above to generate higher-resolution radar point cloud data that is equivalent to using a higher-resolution radar sensor. Consider one such radar point cloud sample as x, using the same notation in the above description. The radar point cloud can be represented as a list with dimensions (N, m) where N is the number of points in the point cloud and m is the length of the feature vector corresponding to each point. In the most basic setting, we would have a feature vector of length m=5 per point consisting of the following real numbers: (x, y, z, rᵥ, rcs), where (x, y, z) form the 3D cartesian coordinates of the point, rᵥ is the signed scalar radial velocity of the point, and rcs is a real number in the interval [0, 1] that depends on the properties of the object from which the radar reflection occurs. Another popular method to represent point cloud data is using so called range-maps which are tensors of the radar data obtained through a voxelization process. The range values are obtained by converting the cartesian (x, y, z) radar reflections into spherical coordinates of (range, azimuth, elevation). The range values are used to obtain a range-map by discretizing the azimuth and elevation coordinates of the reflections. This voxelization process also converts the data from a list of N points (i.e., an irregular grid) into a regular grid where the rows represent the discretized elevation axis, and the columns represent the discretized azimuth axis. The advantage of the regular grid representation is that it enables one to use Convolutional Neural Network (CNN)-based architectures that have been developed in diffusion modeling research for RGB image data. The drawback is that some data could be lost depending on the discretization. Finer grids will reduce this error but could also lead to sparse grids which will then require specialized architectures such as sparse-CNNs for memory efficiency. To summarize, the choice of the data representation informs the choice of the architecture for the conditional diffusion model ϵ_{θ}(zᵢ₊₁, i+1, c). For the list-based (irregular grid) representation, one can choose from the following architectures: PointNet++, Point-GNN, Pointpillars, and Point-Voxel CNN, while for the range-map (regular grid) representation, one can choose the Attention U-Net or the UViT architecture.

For training diffusion model to perform super-resolution, the conditioning c may be a lower-resolution radar point cloud that is sub-sampled from the corresponding higher-resolution radar point cloud data sample x₀ or an input from a lower-resolution radar sensor mounted on the same vehicle as the expensive higher-resolution radar sensor, with a timestamp closest to the higher-resolution data sample. Using the conditioning, the diffusion model can be trained to generate the higher-resolution radar point cloud given a lower-resolution radar point cloud.

In disclosed embodiments, conditioning need not be restricted to a single modality. Data from other modalities such as the RGB image from a camera, data from an event-camera, and/or sonar sensors mounted on the same vehicle can also be used in addition to the low-resolution radar point cloud. In this manner, additional context may be provided that may potentially help the diffusion process to determine the plausibility of the predicted points in the high-resolution point-cloud output.

The problem of performing super-resolution also may be viewed as a point cloud completion problem. This problem can be thought of as inpainting for point clouds. Prior work uses this idea for the problem of shape-completion for data from the ShapeNet dataset wherein a diffusion model is given an incomplete point cloud of a specific shape (e.g., airplane, car, chair, etc.) and is tasked with completing or filling-in the rest of the point cloud. The proposed framework fixes the total number of points (N) in the point cloud and then freezes a subset of the points (ñ) which are provided as an input to the diffusion model. The rest of the points (N−ñ) are randomly initialized by sampling from individual Gaussian distributions and the diffusion model learns to only diffuse the unfrozen (N−ñ) subset of the point cloud. The frozen section can be thought of as a conditioning to the diffusion process. While prior art does not provide any additional conditioning input to the diffusion model, disclosed embodiments may also consider providing an RGB image from a camera or data from an event-camera or data from sonar sensors that are mounted to a vehicle as an additional conditioning input.

In accordance with disclosed embodiments, a diffusion model may be trained in the following manner. Start with a radar point cloud dataset D, wherein samples from the dataset D are considered higher-resolution samples received from a higher-resolution sensor; a deep neural network ϵ_{θ} initialized with random weights θ; a neural network to compute the conditioning input c=f_{ϕ} parameterized by weights ϕ; and other samples including radar point cloud samples from one or more sensors having a lower resolution than the samples in dataset D. In some embodiments, the other samples may include RGB image data, LiDAR data, data from event-cameras, and/or or sonar data. Each of the other samples corresponds to a sample in the dataset D. The following steps may be performed:
i. Randomly sample a mini-batch of higher-resolution radar point cloud samples from D;
ii. Randomly sample steps from {1, 2, 3, . . . , N} of the same size as the mini-batch in step (i.);
iii. Using equation (2) compute the corresponding noisy data samples for each sample in the mini-batch where the amount of corruption depends on the sampled step for the corresponding mini-batch element;
iv. For each element in the mini-batch, compute a corresponding conditioning input c from the corresponding lower-resolution radar point cloud as well as, if present, the corresponding RGB camera image, data from an event camera, and/or corresponding sonar data;
V. Using the results of steps (iii) and (iv) compute ϵ_{θ}(zᵢ₊₁, i+1, c) as described above for each mini-batch element;
vi. Compute a loss function that is the mean of the squared error between ϵ_{θ}(zᵢ₊₁) i+1, c) and the noise e used in step (iii.), over all mini-batch elements;
vii. Compute the gradient of the loss function with respect to the weights θ and ϕ and update the weights in the opposite direction of the gradient scaled by a pre-determined learning rate or a learning-rate scheduler;
viii Repeat the steps starting from (i) until a convergence criterion is met.

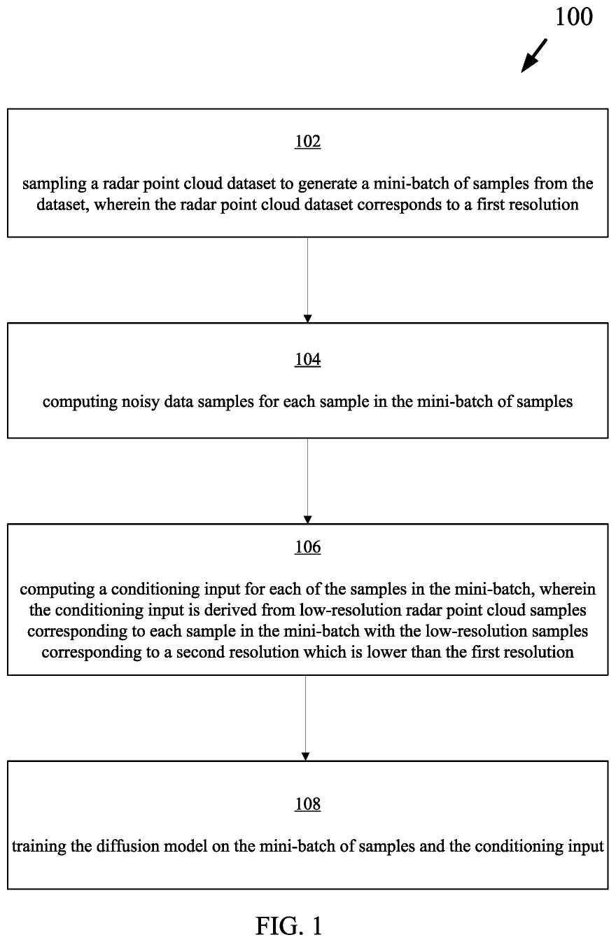

FIG. 1 illustrates a flowchart of an example method 100 in accordance with disclosed embodiments. The method 100 may be used to train a diffusion model in accordance with disclosed embodiments. At operation 102, the method 200 samples a radar point cloud dataset to generate a mini-batch of samples from the dataset, wherein the radar point cloud dataset corresponds to a first resolution. At operation 104, the method 200 computes noisy data samples for each sample in the mini-batch of samples. At operation 106, the method 200 computes a conditioning input for each of the samples in the mini-batch, wherein the conditioning input is derived from low-resolution radar point cloud samples corresponding to each sample in the mini-batch with the low-resolution samples corresponding to a second resolution which is lower than the first resolution. At operation 108, the method 100 trains the diffusion model on the mini-batch of samples and the conditioning input.

A diffusion model trained in accordance with disclosed embodiments may be used to generate higher-resolution radar point clouds. For example, disclosed embodiments may perform the following operations.
i. Randomly sample a noisy radar point cloud zₙ˜ [symbol] (0, I) of the same resolution as the desired clean higher-resolution radar point cloud sample;
ii. Compute the conditioning input c using the inputs from the lower resolution sensor any other low-cost sensors such as RGB cameras, event-cameras or sonar if available, and compute ϵ_{θ}(z_{N}, N, c);
iii. Going backwards in a reverse order starting from i=N−1 to i=0, do the following:
   a. Compute ϵ_{θ}(zᵢ₊₁, i+1, c);
   b. Using zᵢ₊₁ and ϵ_{θ}(zᵢ₊₁, i+1, c) compute z; i.e., a data sample that has less noise as compared to zᵢ₊₁ using DDPM equations;
iv. The output at the end of the iterative process in step (iii) is z₀ which is the clean higher-resolution radar point cloud that corresponds to the input from the lower-resolution radar sensor.

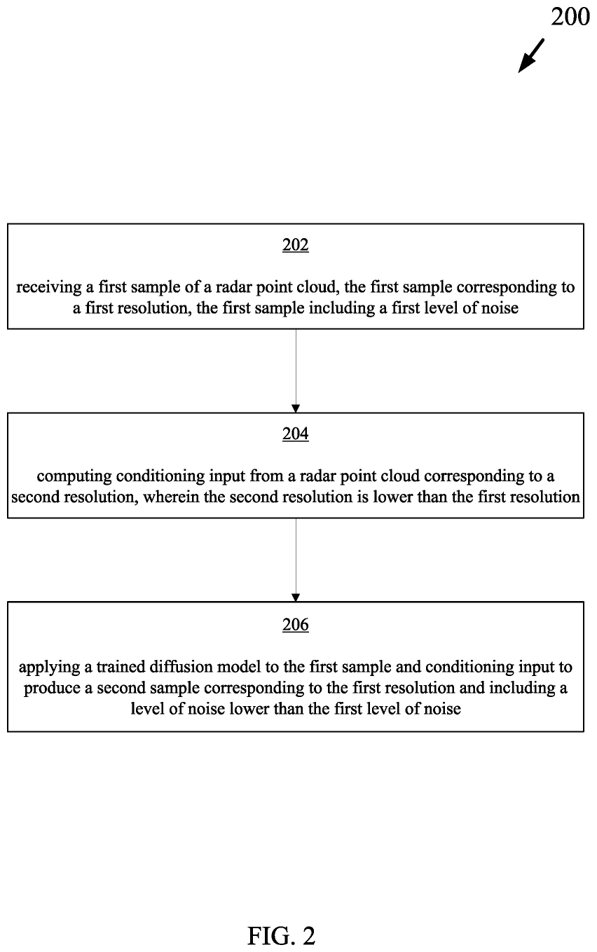

FIG. 2 illustrates a flowchart of an example method 200 in accordance with disclosed embodiments. The method 200 may be used to generate higher-resolution radar point clouds in accordance with disclosed embodiments. At operation 202, the method 200 receives a first sample of a radar point cloud, the first sample corresponding to a first resolution, the first sample including a first level of noise. At operation 204, the method 200 computes conditioning input from a radar point cloud corresponding to a second resolution, wherein the second resolution is lower than the first resolution. Additionally, at operation 204, the method 200 may compute additional conditioning inputs from other lower-cost sensors such as RGB cameras, event-cameras, or sonar, if available. At operation 206, the method 200 applies a trained diffusion model to the first sample and conditioning input to produce a second sample corresponding to the first resolution and including a level of noise lower than the first level of noise.

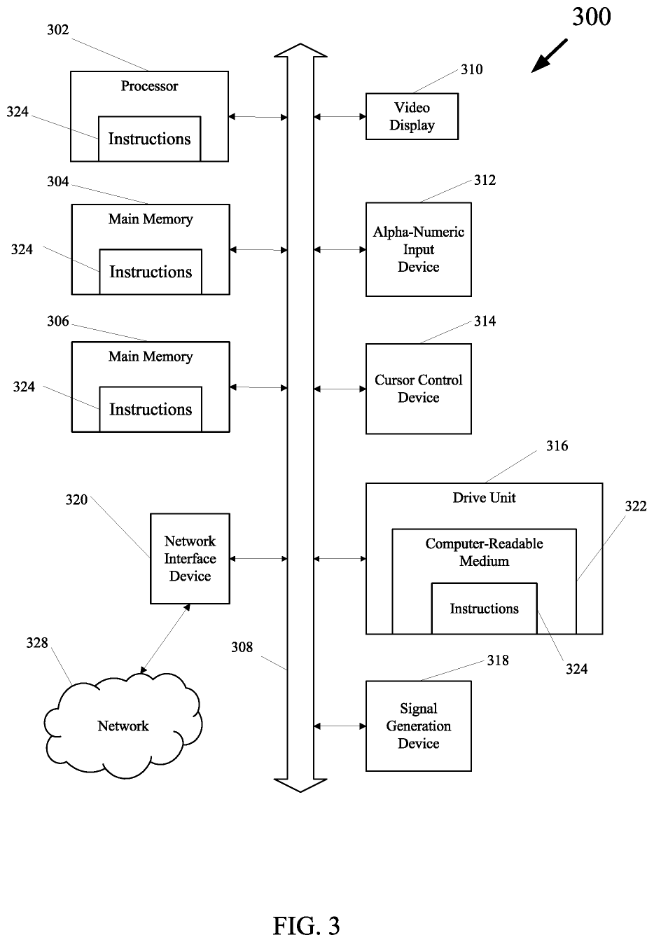

FIG. 3 shows a block diagram of an example embodiment of a general computer system 300. The computer system 300 can include a set of instructions that can be executed to cause the computer system 300 to perform any one or more of the methods or computer-based functions disclosed herein. For example, the computer system 300 may include executable instructions to perform operations disclosed in FIGS. 1 and 2. The computer system 300 may be connected to other computer systems or peripheral devices via a network. Additionally, the computer system 300 may include or be included within other computing devices.

As illustrated in FIG. 3, the computer system 300 may include one or more processors 302. The one or more processors 302 may include, for example, one or more central processing units (CPUs), one or more graphics processing units (GPUs), or both. The computer system 300 may include a main memory 304 and a static memory 306 that can communicate with each other via a bus 308. As shown, the computer system 300 may further include a video display unit 310, such as a liquid crystal display (LCD), a projection television display, a flat panel display, a plasma display, or a solid-state display. Additionally, the computer system 300 may include an input device 312, such as a remote-control device having a wireless keypad, a keyboard, a microphone coupled to a speech recognition engine, a camera such as a video camera or still camera, or a cursor control device 314, such as a mouse device. The computer system 300 may also include a disk drive unit 316, a signal generation device 318, such as a speaker, and a network interface device 320. The network interface 320 may enable the computer system 300 to communicate with other systems via a network 328. For example, the network interface 320 may enable the machine learning system 120 to communicate with a database server (not show) or a controller in manufacturing system (not shown).

In some embodiments, as depicted in FIG. 3, the disk drive unit 316 may include one or more computer-readable media 322 in which one or more sets of instructions 324, e.g., software, may be embedded. For example, the instructions 324 may embody one or more of the methods or functionalities, such as the methods or functionalities disclosed herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In some embodiments, dedicated hardware implementations, such as application specific integrated circuits, programmable logic arrays and other hardware devices, can be constructed to implement one or more of the methods or functionalities described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or functionalities disclosed herein.

In some embodiments, some or all of the computer-readable media will be non-transitory media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium.

Disclosed embodiments be used by receiving sensor signals, from one or more specific sensors, namely lower-resolution radar sensors to compute a control signal for controlling a physical system, e.g., a computer-controlled machine, like a robot or an autonomous vehicle. It does so by generating a higher-resolution output conditioned on the lower-resolution input through a learned iterative denoising process. The end result can then be fed to downstream detection and path-planning algorithms for safe planning and control. The invention can also be extended to receive signals from other sensors such as cameras or sonar which can be combined with the lower-resolution radar input to condition the generation of the higher-resolution radar output. To summarize, the primary application of the invention is to produce radar point-cloud data that is equivalent to using a higher-definition radar sensor but at the cost of more compute and using inputs from lower-resolution sensor(s).

Another application is to significantly limit the number of expensive higher-resolution radar sensors needed for the operation of a fleet of autonomous agents. One can potentially use a single vehicle equipped with a higher-resolution radar sensor(s) as well as cameras and lower-resolution radars to gather data which can then be used to train a diffusion model to generate the data produced by the higher-resolution radar sensor(s) using only the inputs from the lower-resolution radar sensors and cameras or sonar, if available. This therefore promises significant savings in the hardware cost to train and operate a fleet of autonomous vehicles which would only be equipped with the lower-resolution sensors and/or other low-cost sensors.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of training a diffusion model, comprising:
sampling a radar point cloud dataset to generate a mini-batch of samples from the dataset, wherein the radar point cloud dataset corresponds to a first resolution;
computing noisy data samples for each sample in the mini-batch of samples;
computing a conditioning input for each of the samples in the mini-batch, wherein the conditioning input is derived from low-resolution radar point cloud samples corresponding to each sample in the mini-batch with the low-resolution samples corresponding to a second resolution which is lower than the first resolution; and
training the diffusion model on the mini-batch of samples and the conditioning input.

2. The method of claim 1, wherein the conditioning input is further derived from data additional to the low-resolution radar point cloud samples.

3. The method of claim 2, wherein the additional data includes an RGB image, data from an event-camera, LiDAR data, or sonar data.

4. The method of claim 1, wherein computing the conditioning input is performed by a neural network.

5. The method of claim 3, wherein computing the conditioning input is performed by a neural network.

6. A method comprising:
receiving a first sample of a radar point cloud, the first sample corresponding to a first resolution, the first sample including a first level of noise;
computing conditioning input from a radar point cloud corresponding to a second resolution, wherein the second resolution is lower than the first resolution; and
applying a trained diffusion model to the first sample and conditioning input to produce a second sample corresponding to the first resolution and including a level of noise lower than the first level of noise.

7. The method of claim 6, wherein the conditioning input is further computed from data additional to the radar point cloud corresponding to the second resolution.

8. The method of claim 7, wherein the additional data includes an RGB image, data from an event-camera, LiDAR data, or sonar data.

9. The method of claim 6, wherein computing the conditioning input is performed by a neural network.

10. The method of claim 8, wherein computing the conditioning input is performed by a neural network.

11. A system comprising:
one or more processors; and
memory including processor-executable instructions that when executed by the one or more processors causes the system to perform operations including:
sampling a radar point cloud dataset to generate a mini-batch of samples from the dataset, wherein the radar point cloud dataset corresponds to a first resolution;
computing noisy data samples for each sample in the mini-batch of samples;
computing a conditioning input for each of the samples in the mini-batch, wherein the conditioning input is derived from low-resolution radar point cloud samples corresponding to each sample in the mini-batch with the low-resolution samples corresponding to a second resolution which is lower than the first resolution; and
training the diffusion model on the mini-batch of samples and the conditioning input.

12. The system of claim 11, wherein the conditioning input is further derived from data additional to the low-resolution radar point cloud samples.

13. The method of claim 12, wherein the additional data includes an RGB image, data from an event-camera, LiDAR data, or sonar data.

14. The method of claim 11, wherein computing the conditioning input is performed by a neural network.

15. The method of claim 13, wherein computing the conditioning input is performed by a neural network.
